(19) United States
(12) Patent Application Publication
(10) Pub. No.: US 2024/0257146 A1
(43) Pub. Date: Aug. 1, 2024

(54) SYSTEM AND METHOD FOR ROADSIDE ASSISTANCE PROVIDER SELECTION USING PREDICTIVE MODELS

(71) Applicant: Allstate Insurance Company, Northbrook, IL (US)

(72) Inventors: Kristopher Mark Valas, Orlando, FL (US); Swathi Polavarapu, Cumming, GA (US); William John Benjamin, Northbrook, IL (US); Quoc Bao Vo, Chicago, IL (US)

(21) Appl. No.: 18/104,555

(22) Filed: Feb. 1, 2023

(51) Int. Cl. G06Q 30/016; G06Q 30/0282

(52) U.S. Cl. CPC G06Q 30/016; G06Q 30/0282

(57) ABSTRACT

Implementations include providing assistance services, and more specifically for selecting a roadside assistance provider from a plurality of providers using one or more predictive models of aspects of a roadside assistance request. Selection of the roadside assistance provider may be based on ranking of roadside assistance providers associated with a service area, the ranking based on one or more predicted output values from one or more predictive models of aspects of a roadside assistance service, such as estimated arrival time and an estimated probability of acceptance of the request by a roadside assistance provider. The predictive models or other components of the roadside assistance system may be machine-learning and adaptable based on historical data and feedback information of responses and rankings to prior roadside assistance requests.

### TECHNICAL FIELD

Aspects of the present disclosure generally relate to systems and methods for providing assistance services, and more specifically for selecting a roadside assistance provider from a plurality of providers using one or more predictive models of aspects of a roadside assistance request.

### BACKGROUND

Traveling, particularly to international destinations, may involve various unforeseen events and conditions. For example, vehicles may become disabled during a trip because of, for example, a vehicle malfunction, an accident, etc. A disabled vehicle may be a stressful situation for an owner or operator of a vehicle. The drivers and/or passengers of the disabled vehicle may contact a towing network for assistance. In some situations, the towing network might not have available service vehicles, replacement parts, or repair know how to assist the disabled vehicle. Specifically, roadside assistance service providers provide towing services, flat tire assistance, fuel services, automobile repairs, oil changes, and scheduled maintenance appointments, etc. Additionally, some vehicles may breakdown more than others and may need special assistance.

Many drivers use a roadside assistance controller that selects a roadside assistance from available providers in the area of the disabled vehicle and dispatches the selected provider to provide the assistance. However, selection of a roadside assistance provider to a disabled vehicle may oftentimes be expensive and difficult to schedule. For example, the controller may select a roadside assistance provider from a group of available providers and request services. Most prior art systems might auto assign roadside assistance service providers or tow truck drivers solely based on the proximity to a distressed vehicle. The selected provider may reject the request for various reasons, requiring the controller to identify another provider until the request is accepted, wasting time and resources. Further, a dispatched provider often cannot reach the disabled vehicle for a lengthy amount of time, diminishing the experience of the driver and the passengers as they wait for the assistance.

It is with these observations in mind, among other, that aspects of the present disclosure were conceived.

### SUMMARY

Implementations described and claimed herein address the forgoing by providing systems and methods for roadside assistance. In one implementation, a method may include the operations of determining, based on information received from a roadside assistance request, a plurality of roadside assistance providers associated with a service area corresponding to the roadside assistance request and receiving one or more predicted values from a plurality of prediction models, wherein each of the one or more predicted values corresponds to an aspect of providing the requested roadside assistance and associated with each of the plurality of roadside assistance providers. The method may also include the operations of ranking the plurality of roadside assistance providers based at least on one of the one or more predicted values from the plurality of prediction models, selecting, based on the ranked plurality of roadside assistance providers, a roadside assistance provider to provide the requested roadside assistance in response to the roadside assistance request, and altering, based on feedback information associated with the selected roadside assistance provider providing the requested roadside assistance, at least one of the plurality of prediction models.

In another implementation, a roadside assistance provider selection system comprising a processing device in communication with a network and receiving a roadside assistance request from a mobile device, the roadside assistance request comprising at least a geographic location and a non-transitory database for a plurality of roadside assistance providers each associated with a corresponding service area. The processing device executes one or more instructions that cause the processing device to perform several operations, including determining, based on the geographic location, a subset of roadside assistance providers associated with a service area corresponding to the roadside assistance request, calculating an estimated distance for each of the subset of roadside assistance providers based on the geographic location, and receiving, based on the estimated distance for each of the subset of roadside assistance providers, one or more predicted values from a plurality of prediction models, wherein each of the one or more predicted values corresponds to an aspect of providing the requested roadside assistance and associated with each of the subset of roadside assistance providers. The operations may also include ranking the subset of roadside assistance providers based at least on one of the one or more predicted values from the plurality of prediction models and altering, based on feedback information associated with the selected roadside assistance provider providing the requested roadside assistance, at least one of the plurality of prediction models.

In another implementation, one or more tangible non-transitory computer-readable storage media storing computer-executable instructions for performing a computer process on a server of a network is described. The computer process may comprise the method of determining, based on information received from a roadside assistance request, a plurality of roadside assistance providers associated with a service area corresponding to the roadside assistance request, receiving one or more predicted values from a plurality of prediction models, wherein each of the one or more predicted values corresponds to an aspect of providing the requested roadside assistance and associated with each of the plurality of roadside assistance providers, and ranking the plurality of roadside assistance providers based at least on one of the one or more predicted values from the plurality of prediction models. The method may also include selecting, based on the ranked plurality of roadside assistance providers, a roadside assistance provider to provide the requested roadside assistance in response to the roadside assistance request and altering, based on feedback information associated with the selected roadside assistance provider providing the requested roadside assistance, at least one of the plurality of prediction models.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 depicts an illustrative operating environment for providing travel roadside assistance.

FIG. 2 is a flowchart illustrating an example method for selecting a roadside assistance vehicle or other service in response to a request for such a service.

FIG. 3 illustrates a flowchart for a roadside assistance provider ranking system to utilize one or more predictive models to generate a ranked list of roadside assistance providers for dispatching to a disabled vehicle.

FIG. 4 depicts an illustrative roadside assistance provider ranking system utilizing one or more predictive models to generate a ranked list of roadside assistance providers for dispatching to a disabled vehicle.

FIG. 5 illustrates a flowchart for applying weighted values to an aggregated ranked list of roadside assistance providers for dispatching to a disabled vehicle.

FIG. 6 is a flowchart illustrating an example method for applying one or more weighted values to outputs of predictive models for ranking roadside assistance providers for dispatching to a disabled vehicle.

FIG. 7 is a flowchart illustrating an example method for altering a component or aspect of a roadside assistance system based on feedback information and data.

FIG. 8 shows an example computing system that may implement various systems and methods discussed herein in accordance with aspects of the disclosure.

### DETAILED DESCRIPTION

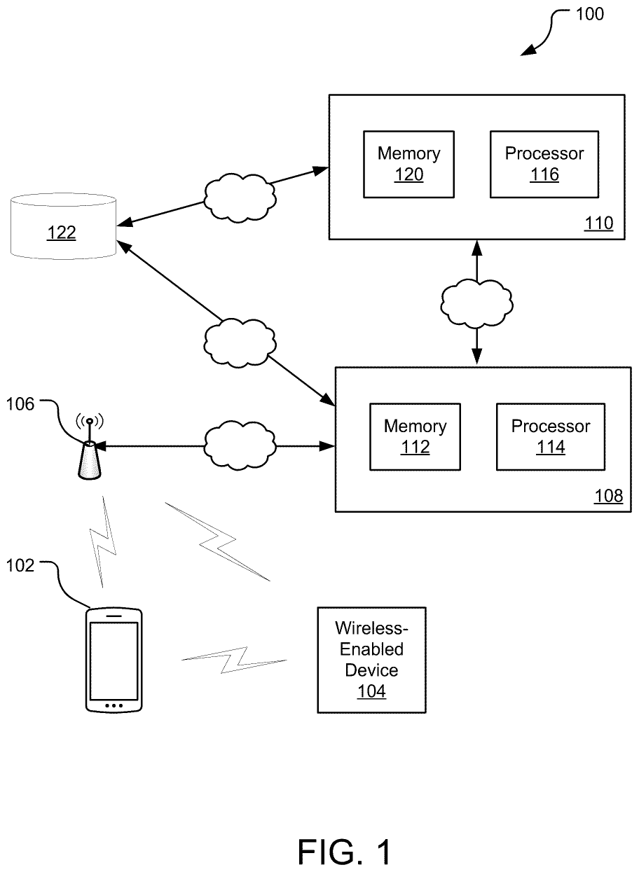

FIG. 1 depicts an illustrative operating environment 100 in accordance with aspects of the disclosure. In one implementation, a user of wireless-enabled devices 102, 104 may communicate with a wireless access point 106. The wireless-enabled device 102 may be a mobile telephone with applications and other functionality, a handheld device with Wi-Fi connectivity, a mobile telephone with travel assistance application installed, or other portable electronic device. The wireless-enabled devices 102, 104 may be configured to communicate with a wireless access point 106 such as a cellular tower operated by a cellular service provider. Alternatively, the wireless access point 106 may be a Wi-Fi-enabled hotspot where the wireless-enabled device 102, 104 may obtain access to the Internet (e.g., to communicate using online chat applications or voice-over-IP applications). In yet another example, the wireless-enabled device 104 may be integrated into or otherwise associated with an automobile to communicate over the wireless network or a satellite-based communication system such that the wireless access point 106 may be satellite device. One skilled in the art will appreciate that other techniques may be used to allow devices 102, 104 access over a wide area network (WAN) or any other type of communications or data networks.

The data communicated from the user devices 102, 104 may be transmitted to a server 108. The server 108 or other type of computing device may include a memory 112 storing computer-readable instructions and a processor 114 for executing the computer-readable instructions. The data communicated to the server 108 from the user device 102, 104 may be transmitted over the WAN through wireless access point 106. Meanwhile, another server 110 may be comprised of a memory 120 storing computer-readable instructions and a processor 116 for executing the computer-readable instructions in accordance with aspects of the disclosure. The memories 112, 120 may also store computer data files that hold information that may be useful to applications running on the user's mobile device 102, 104 or the servers 108, 110. For example, the computer data files may include user login/profile information, insurance policy (or motor club) information, service provider list and related information, databases of information for identifying and selecting roadside service providers, and/or other information. The data collected and stored in the data files may be used to support one or more of the numerous features disclosed throughout this disclosure. Both or either first server 108 or another server 110 may store and access data through data store 122, accessible through a network connection.

One skilled in the art will appreciate that the server (e.g., servers 110 and 108) is not limited to a single machine or device. The server may be embodied as a web server or Internet-accessible server. Furthermore, the term server refers to any system of computers and/or devices (e.g., firewalls, routers, caching systems, proxy servers, etc. or combination thereof) that may be used to provide access to services and features available for use. As such, different reference to the server performing particular steps does not require that the same machine/device perform all the steps.

Servers (108 and 110), data store 122, and wireless access point 106 may communicate over a wired and/or wireless connection. In some instances, a private, secure connection may be established between one or more of these components. For example, server 108 and server 110 may communicate over a network cloud representing the Internet. Alternatively, server 108 and data store 122 may communicate over a secure WAN or a dedicated T1 (or other telecommunications) line. Furthermore, wireless devices 102, 104 may include a processor, memory, display screen (e.g., touchscreen), keypad, sensors (e.g., motion, light, etc.), camera, global positioning system (GPS) chip, audio output/input devices, and other electronic components configured for use in mobile phones, PDAs, and mini-laptops.

Such a server may operate in a networked environment supporting connections to one or more remote computing devices. The remote computing devices may be personal computing devices or servers that include many or all of the elements described below relative to the server. Remote computing devices may be a mobile device communicating over wireless carrier channel. The network connections depicted in the figures may include a local area network (LAN) and/or a wide area network (WAN), but may also include other networks. When used in a LAN networking environment, the server may be connected to the LAN through a network interface or adapter in the communications module. When used in a WAN networking environment, the server may include a modem in the communications module or other means for establishing communications over the WAN, such as the Internet. Multiple instances of the servers 110, 108 may be located at sites around the world to reduce the transmission distance of communications between the servers and the mobile device 102. It will be appreciated that the network connections shown and described are illustrative and other means of establishing a communications link between the computing devices may be used. The existence of any of various well-known protocols such as TCP/IP, Ethernet, FTP. HTTP and the like is presumed, and the system can be operated in a client-server configuration to permit a user to retrieve web pages from a web-based server. Any of various commonly known web browsers can be used to display and manipulate data on web pages. In one implementation, a roadside assistance system for dispatching a roadside assistance vehicle or implement some other type of roadside assistance response to a user associated with a mobile device 102, 104 or a disabled or other type of vehicle may be implemented servers 108, 110. The roadside assistance system is described in greater detail below.

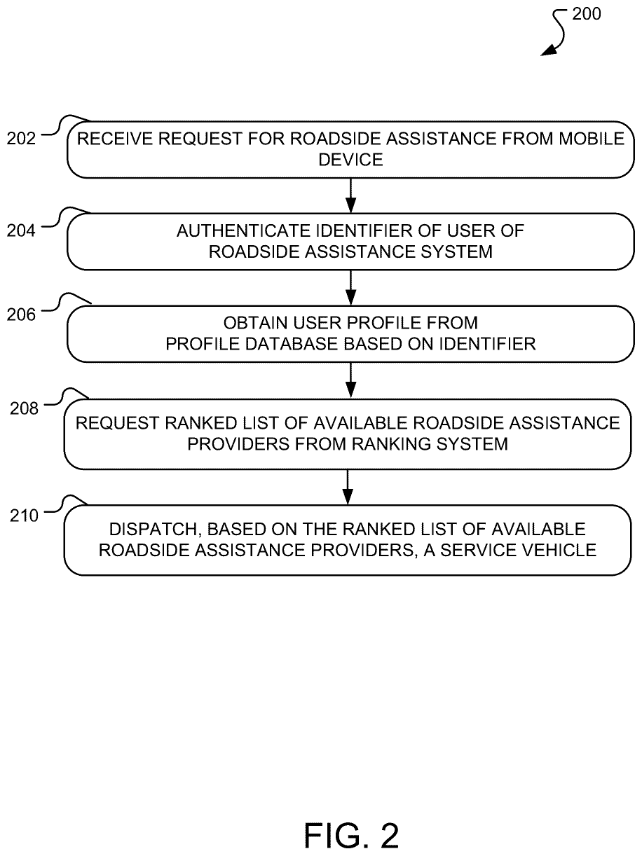

FIG. 2 is a flowchart illustrating an example method 200 for dispatching a roadside assistance vehicle or other service in response to a request for such a service. Aspects of the method 200 may be performed by one or more components of the roadside assistance operative environment 100 described with relation to FIG. 1. In other implementations, the operations of the method 200 of FIG. 2 may be performed by components other than those described with relation to the roadside assistance operative environment 100. In operation 202, a request for a roadside assistance may be received at a roadside assistance system. For example, a user of the roadside assistance system may access an application executed on the mobile device 102, 104 to request a roadside service from a roadside provider, such as a tow, a tire change, a battery service, fuel refill, or any other roadside service. In some instances, the mobile device 102, 104 may automatically transmit a request for roadside assistance upon detection of a condition of a vehicle. For example, one or more sensors associated with a vehicle may detect a flat tire, electrical issues, or any other condition that may impact the operation of the vehicle and, upon the detection, may request a roadside assistance for the disabled vehicle. The request may include, among other information, an identification of the user, a description of the vehicle, an estimated location of the vehicle/mobile device, an estimated condition of the vehicle, and/or any other information that may aid a roadside assistance provider in providing the requested service.

The request for the roadside assistance may be received at a roadside assistance controller executed by server 108, 110. The roadside assistance controller may, in general, select or otherwise identify a roadside assistance provider from a plurality of roadside assistance providers in the vicinity of the disabled vehicle associated with the request. For example, the request for roadside assistance may include a geographic location of the disabled vehicle, such as a city/state location, a longitude/latitude location, a neighborhood identifier, etc. As explained in more detail below, the estimated geographic location of the disabled vehicle may be provided to a roadside assistance provider ranking system for identification of roadside assistance providers that operate near the area of the disabled vehicle or are otherwise associated with the location of the disabled vehicle.

At operation 204, the identification of the user associated with the request for the roadside assistance may be authenticated. For example, the request for roadside assistance may include a user identifier, a name, an identification number, a password, and the like associated with a registered user of the system. In another example, the request may include a unique identifier of the disabled vehicle, such as a vehicle identification number (VIN). The received user identifier and/or password may be compared to a database of registered users of the roadside assistance system and, if included in the database, the user may be authenticated with the roadside assistance system. Upon authentication, a user profile associated with a user identifier may be obtained from the same or a different database of user information. The user profile may include any information associated with the user and provided to the roadside assistance system, including but not limited to, a make and model of the user's vehicle, a history of user's driving habits, a history of the user's interactions with the roadside assistance system, one or more preferences for roadside assistance, geographic locations associated with the user (such as home address, work address, often visited locations, etc.), and the like. The user profile may be used by the roadside assistance system to identify or select a roadside assistance provider for dispatching to the user's location.

At operation 208, the roadside assistance system may request a ranked list of available roadside assistance providers associated with the provided location of the disabled vehicle. The request for a ranked listing of available roadside assistance providers may include any information or data that may aid a ranking service in identifying available roadside assistance providers associated with the provided location, selecting one or more available roadside assistance providers, and/or ranking a plurality of available roadside assistance providers for the indicated location. For example, the request for a ranked listing of available roadside assistance providers may include an estimated geographic or other location of the disabled vehicle or user, a make, model, year of manufacturer or any other manufacturing information of the disabled vehicle, an estimated condition of the disabled vehicle (including potential remedial actions to fix the disabled vehicle, user information obtained from the user profile or provided through the mobile device, a membership of the user or vehicle to a party in partnership with the roadside assistance controller, and the like. One or more of the above listed information may alternatively be obtained by the roadside assistance providers ranking system upon receiving the request for a ranked list of available roadside assistance for the location associated with the disabled vehicle and/or mobile device 102, 104. The ranking of the one or more roadside assistance providers is described in greater detail below.

At operation 210, one or more roadside assistance providers may be dispatched to the location of the user, the mobile device 102, 104 based on the ranked list of available roadside assistance providers received from the roadside assistance providers ranking system. In some instances, the roadside assistance system may select the roadside assistance provider that is listed first in the ranked list of available roadside assistance providers for that area. In other instances, the roadside assistance system may select any provider in the ranked list. The roadside assistance system may contact the selected roadside assistance provider from the ranked list to dispatch the provider to the disabled vehicle. In some instances, the roadside assistance system may track the progress of the roadside assistance provider to the disabled vehicle to ensure that the provider arrives and performs the requested service on the vehicle. In this manner, a roadside assistance service may be received at the roadside assistance system and a provider may be dispatched based on a ranking of such providers associated with the area around the disabled vehicle.

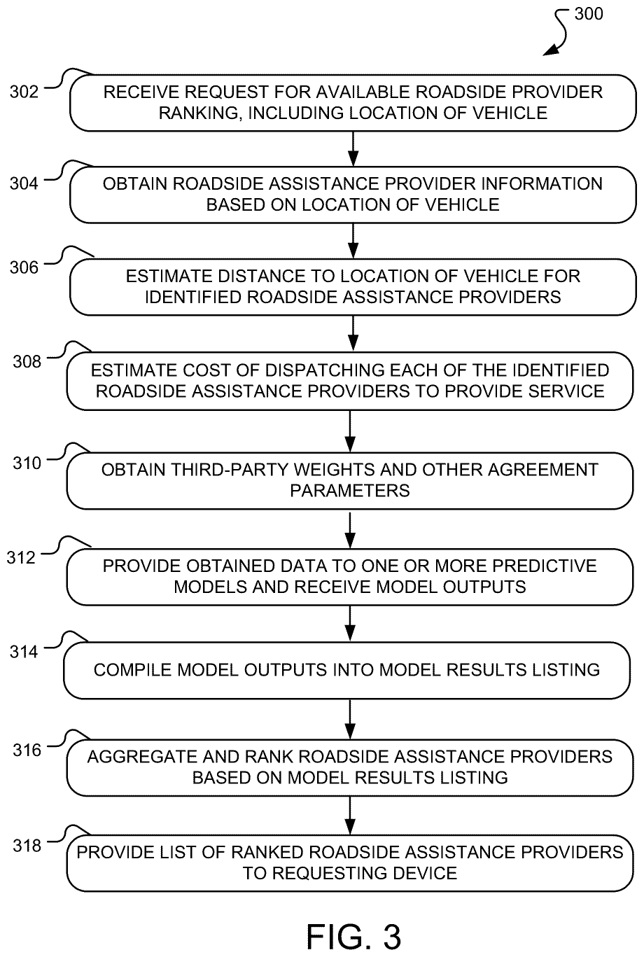

The ranking of the available roadside assistance providers associated with a location or area of a disabled vehicle may be based on many factors, including estimated time for each of the available providers to arrive at the disabled vehicle, a cost for dispatching the roadside assistance provider to provide the requested service, user information and preferences, one or more business agreements with third parties to which the user may be a member or otherwise associated, combinations of two or more such factors, and the like. In addition, a roadside assistance provider ranking system may utilize one or more predictive models to generate data associated with the above factors and utilize the generated data for ranking the available roadside assistance providers. FIG. 3 illustrates a flowchart for method of a roadside assistance provider ranking system utilizing one or more predictive models to generate a ranked list of roadside assistance providers for dispatching to a disabled vehicle. The operations of the method 300 may be performed by the roadside assistance provider ranking system, as executed by server 108 or 110 of the environment 100 of FIG. 1 or any other computing device as a component of a roadside assistance system.

At operation 302, the roadside assistance provider ranking system may receive a request for a ranking of available roadside assistance providers. The request may include such data as an estimated location of the vehicle (obtained from a mobile device 102, 104 associated with a user of the system, coordinated obtained from a Global Positioning System (GPS) device associated with the vehicle, and the like), an identification of the a requesting party (such as a user identifier and/or password of a user of the system), make and/or model of the vehicle associated with the request, and any other information or data that may aid the roadside assistance provider ranking system in ranking roadside assistance providers. At operation 304, the roadside assistance provider ranking system may obtain roadside assistance provider information based on the location of the vehicle for which roadside assistance is requested. In general, a database of roadside assistance providers may be generated and indexed based on an area of service available from each of the providers. For example, the location of the vehicle may include a city identifier or an identifier of a portion of a city. Based on the location information, the roadside assistance provider ranking system may access the database of available roadside assistance providers and obtain the providers that service the city or portion of the city indicated in the location information. In this manner, the roadside assistance ranking service may determine which roadside assistance providers may be available to provide a requested service to the vehicle. In some instances, the roadside assistance provider information in the database may be provided by the roadside assistance providers themselves for inclusion in the database. In other instances, the roadside assistance providers ranking system or other roadside assistance system may access one or more public or private databases to determine which roadside assistance providers are active for a given location and include the identified providers into the database with a corresponding service area for each included provider.

In many instances, a plurality of roadside assistance providers may be associated with a given area or location and obtained by the roadside assistance providers ranking system. However, in more remote locations, there may not be any identified roadside assistance providers for a given location. The roadside assistance providers ranking system may, in such circumstances, alter the location information of the vehicle in order to identify a roadside assistance provider that may service the vehicle. For example, the location of the vehicle may be altered to include a wider potential service area around the location of the vehicle to improve the chances of identifying a roadside assistance provider for the area. The system may continue to expand the area of service around the vehicle until at least one service provider is identified in the database. In some instances, an upper limit to the service area associated with the location of the vehicle may be set that halts the expansion of the service area of the vehicle after a number of alterations. The roadside assistance provider ranking system may return an indication that no roadside assistance providers are available for the vehicle location in such circumstances.

At operation 306, an estimated distance of travel for a service truck to reach the disabled vehicle for each of the identified roadside assistance providers may be determined or estimated. For example, the roadside assistance provider ranking system may identify five roadside assistance providers associated with the location of the vehicle from the roadside assistance provider database. Each identified provider may include a home location from which a service truck may be dispatched to provide roadside assistance to vehicles, such as a street address of a dispatch center for the provider, a storage lot for the service trucks for the provider, an estimated current location for the nearest provider truck, or any other home location as provided by the roadside assistance providers in the database. The ranking system may thus estimate or otherwise calculate a distance from the home location to the disabled vehicle for each of the five roadside assistance providers identified from the database. Instances in which more or fewer roadside assistance providers are identified, a corresponding distance from the provider's home location to the vehicle may be estimated or calculated for each of the identified providers.

Similarly, at operation 308, an estimated cost to dispatch each of the identified roadside assistance providers to provide the requested service on the vehicle may be determined. In some examples, the estimated cost to dispatch a roadside assistance truck to the vehicle may be based on the determined distance to the vehicle and/or the type of roadside service requested. Other factors may affect the estimated cost for dispatching a roadside assistance provider to the vehicle, such as but not limited to, a pricing structure associated with each of the identified roadside assistance providers, one or more current, past, or forecasted environmental conditions at the time of the request for roadside assistance, a number of available roadside assistance providers and/or trucks in the area, and the like. As explained in more detail below, the estimated cost for dispatching one or more of the roadside assistance providers may be adjusted by the roadside assistance provider ranking system in response to other factors.

At operation 310, one or more weighted values associated with one or more third parties may be obtained from a database of such weighted values. In particular, one or more third parties may enter into an agreement with an operating entity of the roadside assistance controller that may be used by the roadside assistance provider ranking system to adjust a ranking of available providers. For example, an automobile manufacturer may enter into an agreement with the roadside assistance provider ranking system to ensure a level of roadside assistance for each vehicle of that manufacturer that is registered with the system. In another example, a third-party roadside assistance controller may include a membership service that ensures members requesting roadside assistance through the controller receives a particular service level, such as dispatch of a service truck within a particular timeframe, a certain cost for the roadside assistance, and the like. The third-party roadside assistance controller may thus enter into an agreement with the ranking system to ensure that each dispatched provider to a member of the group receives the agreed upon level of service. The use of the weighted values associated with the one or more third-party entities is discussed in more detail below with reference to the ranking of the identified roadside assistance providers.

At operation 312, a portion of all of the above obtained data and information may be provided to one or more predictive models to predict a performance of the identified roadside assistance providers based on the obtained data and information. The roadside assistance provider ranking system may include any number of such predictive models. For example, a model may be accessed that outputs an estimated or predicted arrival time of one or more of the identified roadside assistance providers to the vehicle. The time to arrival model may receive the estimated location of the vehicle and the home location of a roadside assistance provider and generate an estimated arrival time. In some instances, other inputs may be provided to the arrival time model, including but not limited to, current traffic conditions of the area near the vehicle and/or home location of the roadside assistance provider, current weather conditions in the vicinity of the vehicle, a priority ranking for the user requesting the roadside assistance, and the like. Further, the time to arrival model may be based on historical data associated with the roadside assistance provider, the roadside assistance provider system in general, and/or any other historical data that may be used to train the time to arrival model.

In another example, an acceptance model may be accessed or otherwise utilized at operation 312. The acceptance model may receive data or information related to the requested roadside assistance and output an estimated likelihood of the corresponding roadside assistance provider accepting the request to provide the roadside assistance. In particular, each of the roadside assistance providers may accept or deny a request for the roadside assistance. For example, a roadside assistance provider may deny a request for a roadside assistance if all of the available trucks for that provider are currently busy when the request is received. In another example, the roadside assistance provider may deny the request for the roadside assistance if the requested service type is not supported by the provider. Thus, the acceptance model may receive information associated with the roadside assistance and output a likelihood the roadside assistance provider accepts the request for the roadside assistance. In some instances, the likelihood output may be a yes or no indicator, may be a percentage of the likelihood of acceptance, may provide recommendations to improve an estimated acceptance likelihood, and the like. As explained in more detail below, the output of the acceptance model may be based, at least in part, on an offered monetary payment to the provider for providing the requested roadside assistance. Also, as above, the acceptance model may be based on historical data associated with the roadside assistance provider, the roadside assistance provider system in general, and/or any other historical data that may be used to train the time to acceptance model. In this manner, the acceptance model may be a machine-learning model that is trained on historical events in which an offer is made to the roadside assistance provider to dispatch to a vehicle and whether the provider accepted or rejected the request.

Another example predictive model that may be utilized by the roadside assistance provider ranking system is a cost model for providing the requested roadside assistance. The predictive cost model may receive data or information associated with a requested rescue and output an estimated or predicted cost required for a corresponding roadside assistance provider to provide the assistance. The predictive cost model may utilize such inputs as time of day, type of requested rescue, number of available roadside assistance providers in the area of the vehicle, predetermined cost structures for the corresponding roadside assistance provider, variable cost structures for the corresponding roadside assistance provider, and the like. The output predicted cost may be provided to the roadside assistance provider ranking system for use in ranking the available providers. In still other examples, two or more predictive models may be combined and provide a multi-criteria predictive model. Further, the third-party weights obtained above may also be used as inputs to one or more of the predictive models to adjust the results or outputs of the models in favor of particular aspect of the model or multi-criteria model. Use and adjustment to the many predictive models of the roadside assistance provider ranking system is discussed in greater detail below.

At operation 314, the outputs of the various predictive models called by the roadside assistance provider ranking system may be compiled into a results listing. In one example, the outputs may be compiled into a database of results. Once the results from each of the utilized predictive models is compiled into a source of model results, the identified roadside assistance providers may be aggregated and ranked into a ranked list of available providers at operation 316. As should be appreciated, the type of predictive models utilized by the roadside assistance provider ranking system may determine the criteria for the ranked list of the roadside assistance providers. For example, a ranking of the roadside assistance providers may be based on the output of the time to arrival predictive model such that the provider with the fastest estimated time to arrival would be ranked first in the ranked list (or the predicted slowest provider may be ranked first). In another example, a ranking of the roadside assistance providers based on the cost predictive model may rank the provider with the smallest estimated cost to provide the roadside service at the top of the ranked list. Instances in which multiple predictive models or a multi-criteria model is utilized, the ranked list of roadside assistance providers may be based on multiple criteria, including time to arrival, cost, likelihood of acceptance, weighted values, and the like. In this manner, the roadside assistance provider ranking system may obtain multiple ranked lists of the roadside assistance providers based on different criteria through the various predictive models of the system.

At operation 318, the ranked list of roadside assistance providers associated with the area of the vehicle may be returned or otherwise provided to the device requesting the ranked list. For example, the roadside assistance system may transmit a request to the roadside assistance provider ranking system to receive a ranked list of providers in the vicinity of the vehicle. Such a request may include one or more parameters indicating which criteria is included in ranking the available roadside assistance providers. In response, the roadside assistance provider ranking system may generate the ranked list of providers based on the provided parameters and return the list to the roadside assistance system for use in selecting to dispatch one or more of the providers from the ranked list. In some examples, the requesting device may not select a provider from the ranked list of providers to dispatch to the vehicle. In still other examples, the requesting device may transmit an additional request for an additional ranking of the providers based on the same or other parameters or criteria. The predictive models of the roadside assistance provider ranking system, however, provide an additional insight into the likelihood and costs associated with dispatching a roadside assistance provider to a vehicle based on a request for such roadside assistance.

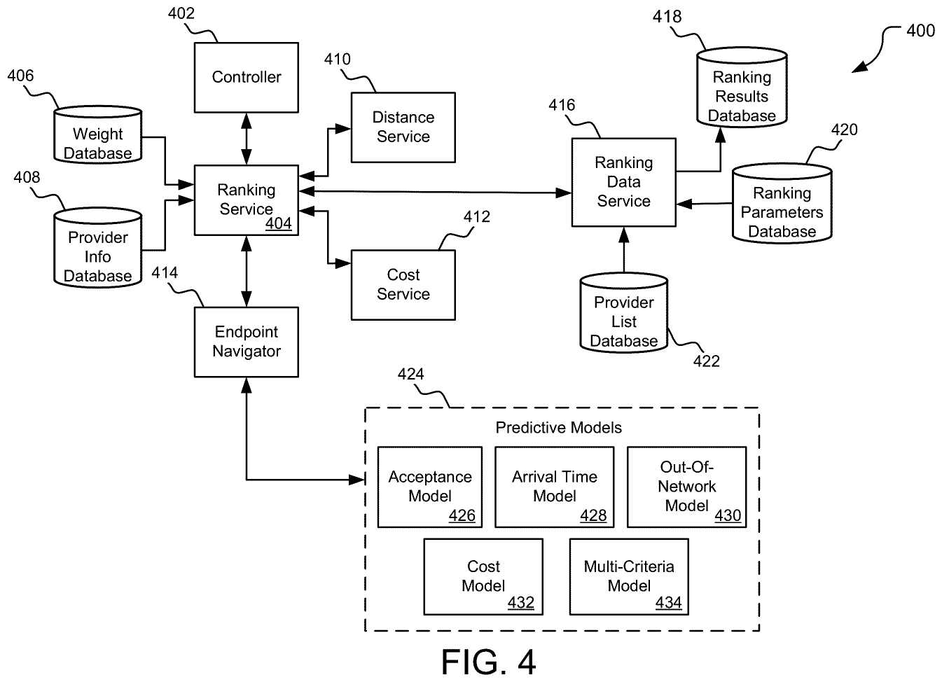

FIG. 4 depicts an illustrative roadside assistance provider ranking system 400 utilizing one or more predictive models 424 to generate a ranked list of roadside assistance providers for dispatching to a disabled vehicle. The system 400 may include more or fewer components than illustrated in FIG. 4 as this is but one example of such as system. As explained above, the roadside assistance provider ranking system 400 may be called by a computing device or system, such as a roadside assistance controller, a third-party roadside assistance provider, a customer to a roadside assistance system, and the like to receive a ranked listing of roadside assistance providers corresponding to a geographic region or area. For example, a vehicle driven by a driver may become disabled due to some faulty condition, such as a flat tire, electrical issue, broken windshield, and the like. The driver may contact a roadside assistance system to request service be performed on the vehicle on the side of the road or to request a tow of the vehicle to a garage or other location to fix the issue. The contact may be made through a phone call, through an application executed on a mobile device, through a dedicated computing device integrated or otherwise associated with the vehicle, or any other communication device. The roadside assistance system may include a controller 402 that coordinates requesting the roadside assistance for the driver. As discussed above with relation to FIG. 2, the roadside assistance system may obtain information and data associated with the vehicle and/or the driver, such as the location of the vehicle, an estimated condition of the vehicle, the make and/or model of the vehicle, a membership of the driver or vehicle in a roadside assistance service, and the like. To determine a roadside assistance provider to dispatch to the vehicle's location, the roadside assistance system may transmit a request, perhaps via a controller 402, to the roadside assistance provider ranking system to receive a ranked list of potentially available providers in the vicinity of the vehicle from which the controller may select.

As illustrated in FIG. 4, the controller 402 may transmit a request or otherwise call a ranking service 404 to provide a ranked list of potentially available roadside assistance providers associated with a disabled vehicle or other type of roadside assistance request. The ranking request may include any of the information noted above that is associated with the vehicle and/or the driver (requestor) of the roadside assistance. Alternatively, the controller 402 may provide a portion of the information received from the requestor's mobile device or vehicle to the roadside assistance provider ranking system 400 via a request, while other information may be obtained from databases associated with the ranking system. Upon receiving the request from the controller 402, the ranking service 404 may call a ranking data service 416. The ranking data service 416 generally manages data and information used to generate a ranked list of roadside assistance providers, such as providing an interface to one or more databases of information that may be utilized by the ranking service 404 to rank the providers. For example, the ranking data service 416 may access a provider list database 422 that includes a listing of some or all of the roadside assistance providers associated with a roadside assistance system. The list of roadside assistance providers may be indexed or searchable based on a geographic location, such as a city identifier, geographic coordinates, or any other identifier of a location. The ranking data service 416 may utilize the location of the vehicle that is the subject of a request for roadside assistance to obtain a list of potential roadside assistance providers from the provider list database 422. The provider list database 422 may be periodically or continually updated with potential roadside assistance providers associated with the roadside assistance system and indexed within the database based on areas of service provided by each listing in the database.

The ranking data service 416 may also obtain one or more ranking parameters from a ranking parameters database 420. Ranking parameters stored in the database 420 may include data or information used by the ranking service 404 for generating a ranked roadside assistance providers list. For example, a ranking parameter may be a rule or other instructions that indicate that ranking of the roadside assistance providers should be based on estimated time to arrival at the vehicle. As explained in more detail below, the ranking service 404 may utilize this preference for fastest arrival time to generate the ranked list of roadside assistance providers. In another example, a ranking parameter may be based on a make and/or model of the vehicle such that the ranking service 404 may generate the ranking of the roadside assistance providers according to the type of vehicle associated with the roadside assistance request. In still another example, the ranking parameter may be based on an identifier of the requestor of the roadside assistance as a member of a group with an agreement with the roadside assistance system such that the ranking service 404 may generate the ranking of the roadside assistance providers according to the agreement. In general, any parameter, preference, or setting may be stored in the ranking parameter database 420 for use by the ranking service 404 to adjust the requested ranking of the roadside assistance providers. The ranking parameters of the database 420 may be updated periodically as preferences of the roadside assistance system. In some instances, the ranking parameters of the database 420 may be updated based on one or more ranking results stored in the ranking results database 418. The adjustment to one or more ranking parameters based on ranking results is described in more detail below.

After receiving the data and/or information from the ranking data service 416, the ranking service 404 may call a distance service 410 to determine an estimated distance to arrive at the disabled vehicle for each of the roadside assistance providers obtained from the provider list database 422. The distance service 410 may utilize contact other databases to determine a distance for each of the identified roadside assistance providers to arrive at the vehicle, including one or more mapping services or databases, one or more traffic services or databases, one or more databases of current environmental or road condition services or databases, and the like. The ranking service 404 may also provide information to the distance services 410 to aid in calculating or estimating a distance for each roadside assistance provider. For example and as explained above, each identified provider may be associated with a home or base location from which a service truck may be dispatched to provide roadside assistance to vehicles. The home location for the roadside assistance providers may be stored in a provider information database 408 that is accessed by the ranking service 404 to obtain the home locations. In general, the provider information database 408 may be populated with various information associated with roadside assistance providers included in the provider list database 422, such as a home location, services provided, number of available trucks, cost structures for providing various roadside services, and the like. The provider information database 408 may be, in some instances, accessible by the roadside assistance providers to update the information stored in the database. For example, a first roadside assistance provider may use a computing device to log into or otherwise access the roadside assistance system and provide operational information to the system, which may then be stored in the provider information database 408 as associated with that particular roadside assistance provider. In other instances, the information in the database 408 may be obtained from one or more third-party sources by the roadside assistance system and used to update the database with the obtained information.

Returning to the above example, the ranking service 404 may provide a home location for each of the roadside assistance providers identified from the provider list database 422 based on the vehicle location to the distance service 410. The distance service 410 may return an estimated distance for each of the roadside assistance providers to arrive at the disabled vehicle. In one particular implementation, the ranking service 404 may receive, and provide to the distances service 410, an estimated location of a particular roadside assistance truck managed by an identified roadside assistance provider. Thus, the estimated distance may include the distance for that particular roadside assistance truck to arrive at the vehicle. In another example, the distance service 410 may return an estimated time to arrival for one or more of the identified roadside assistance providers based on the estimated distance to arrive at the vehicle, the current conditions of the surrounding area, and/or any other information provided to or otherwise obtained by the distance service.

The ranking service 404 may also communicate with a cost service 412 to obtain an estimated cost for the requested roadside assistance for each of the identified roadside assistance providers. In one instance, the ranking service 404 may obtain a cost schedule from the provider information database 408 for each of the identified roadside assistance providers. The cost schedule may include a cost associated with providing the roadside assistance, including costs for miles traveled, costs for various roadside services (change of a flat tire, short tow, long tow, recharge of a car battery, transportation of driver and/or passengers to a destination, etc.), discount rates for particular groups or users, costs associated with periods of high-volume requests, and the like. Each roadside assistance provider may submit a cost schedule to the roadside assistance system for storage in the provider information database 408. Updates to the cost schedule for each roadside assistance provider may also be provided and/or otherwise stored in the provider information database 408. Thus, the ranking service 404 and/or the cost service 412 may obtain the cost schedules for one or more of the identified roadside assistance providers and estimate a cost for each of the providers to respond to the roadside assistance request. In another implementation discussed in more detail below, the ranking service 404 may utilize a predictive cost model that predicts or estimates the cost for the roadside assistance providers to provide the requested service based on historical data of previous roadside assistance requests and dispatches. In such circumstances, the ranking service 404 or may not use the cost service 412 to receive an estimated cost for executing the requested roadside assistance.

In addition to or alternate from the distance service 410 and/or cost service 412, the ranking service 404 may utilize one or more predictive models 424 to aid in generating the ranked list of roadside assistance providers associated with the roadside assistance request. To access the predictive models 424, the ranking service 404 may communicate with an endpoint navigator 414 configured to determine the predictive model or models used in generating the ranked list of roadside assistance providers. In one instance, the endpoint navigator 414 may randomly select one or more of the predictive models 424 through a random number generator or any other technique for randomly selecting from a plurality of models. In another instance, the endpoint navigator 414 may receive one or more ranking parameters from the ranking service 404. The ranking parameters may instruct the endpoint navigator 414 to access particular predictive models of the available predictive models. For example, a ranking parameter obtained from the ranking parameters database 420 may indicate that a ranking of roadside assistance providers based on arrival time is preferred for the particular roadside assistance request. The endpoint navigator 414 may then call or otherwise access the arrival time model 428 of the suite of predictive models 424 to obtain a ranking of the roadside assistance providers based on a predicted arrival time of the providers to the vehicle. To call the arrival time model 428, the endpoint navigator 414 may obtain and transmit one or more inputs to the arrival time model 428, such as a listing of the roadside assistance providers, an estimated location of the vehicle, the determined distance to the vehicle for each of the roadside assistance providers from the distance service 410, and the like. In another example, the inputs to the arrival time model 428 may be provided from the ranking service 404. Regardless, the arrival time model 428 may process the inputs through a machine-learned model to estimate an arrival time at the vehicle for each of the roadside assistance providers. The arrival time may be at least partially based on historical data of arrival times of the roadside assistance providers in response to other roadside assistance requests. The predicted arrival times for the roadside assistance providers may then be returned to the ranking service 404 for use in ranking the identified roadside assistance providers.

In another example, a ranking parameter may indicate that a ranking of roadside assistance providers based on cost is preferred for the particular roadside assistance request. The endpoint navigator 414 may then call or otherwise access the cost model 432 of the suite of predictive models 424 to obtain a ranking of the roadside assistance providers based on a predicted cost of the providers to provide the requested roadside assistance. Inputs to the cost model 432 may include such information and data as the estimated distance for the roadside assistance providers to arrive at the vehicle, a requested roadside assistance service, one or more cost schedules for the roadside assistance providers, a time of day, day of the week, day of the year, or any other information on which a cost to provide a roadside assistance may depend. The cost model 432 may process the inputs through a machine-learned model to estimate a cost for each of the roadside assistance providers to perform the requested roadside assistance. The configuration of the cost model 432 may be at least partially based on historical data of previous costs of the roadside assistance providers to provide the requested roadside assistance or a similar roadside assistance. The predicted costs for the roadside assistance providers to perform the requested roadside assistance may then be returned to the ranking service 404 for use in ranking the identified roadside assistance providers, per the request received at the ranking service.

Still other predictive models may be included or otherwise available in the suite of predictive models 424. For example, an acceptance model 426 may provide a predicted likelihood for each of the roadside assistance providers that the request for the roadside assistance will be accepted by a particular provider. For example, provided with data and information associated with a request for roadside assistance, the acceptance model 426 may return a percentage of likelihood that a particular roadside assistance provider will accept to respond to the request. As such, the output of the acceptance model 426 may indicate the roadside assistance provider has a 90% likelihood of accepting the request for providing the roadside assistance. One input to the acceptance model 426 may be an estimated cost offered to the roadside assistance provider to perform the roadside assistance. The returned indicator from the acceptance model 426 may therefore indicate the likelihood that the roadside assistance provider will accept the requested assistance based on the estimated cost. The returned likelihood indicator from the acceptance model 426 may also be based on whether the roadside assistance provider offers the particular roadside service included in the request for the roadside assistance. For example, a roadside assistance provider that does not offer towing of a vehicle is unlikely to accept a request for roadside assistance that may include towing of the vehicle. This unlikelihood of the roadside assistance providers to accept the request for towing the vehicle may be reflected in the output of the acceptance model 426. As with the other predictive models in the suite of models 424, the acceptance model may be configured or altered through historical data of acceptance rates of the roadside assistance providers in response to previous requests for roadside assistance. In this manner, the acceptance model 426 may be a machine-learned model to predict the likelihood of an acceptance of the roadside assistance request by one or more roadside assistance providers.

Another predictive model of the suite of models 424 is an out of network model 430 that returns a predicted likelihood that the request for the roadside assistance may be accepted by a roadside assistance provider that is out of network of a selected portion of roadside assistance providers. For example, the roadside assistance system may collaborate with particular roadside assistance providers as “in-network” providers. Such providers may be given preference over other roadside assistance providers, referred to as “out-of-network” providers. In some instances, however, a request for a roadside assistance may not be serviced by an in-network provider, such as circumstances in which an in-network roadside assistance provider near the vehicle's location does not perform the requested roadside service. The out-of-network model 430 may therefore return a likelihood that a request for roadside assistance will result in a selection of an out-of-network roadside assistance provider.

Each of the above predictive models 426-432 may provide an output corresponding to one aspect or criteria of a roadside assistance, such as a predicted arrival time, a predicted likelihood of acceptance, a predicted cost for the roadside assistance, and the like. The suite of predictive models 424 may also include one or more models that combine multiple criteria, such as multi-criteria model 434. Multi-criteria models 434 may generate an output of roadside assistance providers based on multiple criteria, such as arrival time and cost. In general, the multi-criteria model 434 may include any aspect of a roadside assistance to generate an output from the model. Further, one or more of the input criteria used by the model 434 may be associated with weighted value. For example, the ranking service 404 may obtain one or more weight values from the weight database 406. Each of the weight values may be associated with a particular criteria for ranking roadside assistance providers as processed through multi-criteria model 434. Foe example, multi-criteria model 434 may be configured to rank the roadside assistance providers based on estimated time to arrival and estimated cost. However, time to arrival may be given a higher weight to favor fast arriving roadside assistance providers over slow arriving providers. In this example, a weighted value of 80 may be applied, within the multi-criteria model 434, to estimated time of arrivals for each of the roadside assistance providers while a weighted value of 20 may be applied to an estimated cost for each roadside assistance provider. Through the weighted values, the time to arrival criteria is given extra importance in the multi-criteria model 434 in comparison to a cost criteria. Other criteria may also be associated with a weighted value and used to generate an output list of the roadside assistance providers by the multi-criteria model 434. The use of weighted values obtained from the weight database 406 is discussed in more detail below.

As noted above, the endpoint navigator 414 may select one or more of the predictive models from the suite of available predictive models 424 for use in generating a ranked list of roadside assistance providers. Such a selection may be made at random or may be based on one or more ranking parameters from the parameters database 420. The selected predictive models 426-434 may generate an output corresponding to the model for each of the roadside assistance providers identified from the provider list database 422. For example, an acceptance model 426 may generate a likelihood of acceptance for one or more of the roadside assistance providers, the arrival time model 428 may provide an estimated arrival time for one or more of the roadside assistance providers, the cost model 432 may provide an estimated cost for selecting a roadside assistance provider to perform the roadside service, the multi-criteria model 434 may provide an output for each of the roadside assistance provider based on multiple criteria, and the like. The output of one or more of the predictive models 426-434 may be provided to the ranking service 404 for aggregation of the results from each model. In one example, the ranking service 404 may aggregate the results from each model into a table or other format for comparison of the various outputs.

The ranking service 404 may also utilize the aggregated outputs from the predictive models 424 to rank the identified roadside assistance providers obtained from the provider list database 422. The ranking service 404 may rank the roadside assistance providers based on any criteria. For example, a ranking parameter from the parameter database 420 may cause the ranking service 404 to rank the roadside assistance providers based on cost only as indicated by the output of the cost model 432. In another example, a ranking parameter may cause the ranking service 404 to rank the roadside assistance providers based on estimated arrival time only. In still another example, a ranking parameter may cause the ranking service 404 to rank the roadside assistance providers based on multiple criteria, either based on the multi-criteria model 434 or from a plurality of outputs of a plurality of predictive models. Ranking the roadside assistance providers based on multiple criteria may involve one or more weighted values from the weight database 406 to tune the rankings of the providers. For example, the weighted values may cause the ranking service 404 to give more weight to a probability of acceptance by the roadside assistance providers over other criteria. In another example, different weighted values may be distributed between multiple criteria, such as a weighted value of 20 applied to an estimated cost, a weighted value of 30 applied to an estimated time of arrival, and a weighted value of 50 applied to a probability of acceptance. In general, the ranking service 404 may rank the roadside assistance providers in any manner based on the results of the predictive models 424, including in response to one or more ranking parameters or other considerations. Upon generating the ranked list of roadside assistance providers, the ranking service 404 may return the list to the controller 402 or other computing device that requested the ranked list of roadside assistance providers. The controller 402 may, in turn, select a roadside assistance provider from the ranked list for dispatching to the vehicle. The selected roadside assistance provider may be from the top of the ranked list, or may be based on any other information. In this manner, the ranking service 404 may provide a ranked list of roadside assistance providers to the controller 402 utilizing one or more of the predictive models 424.

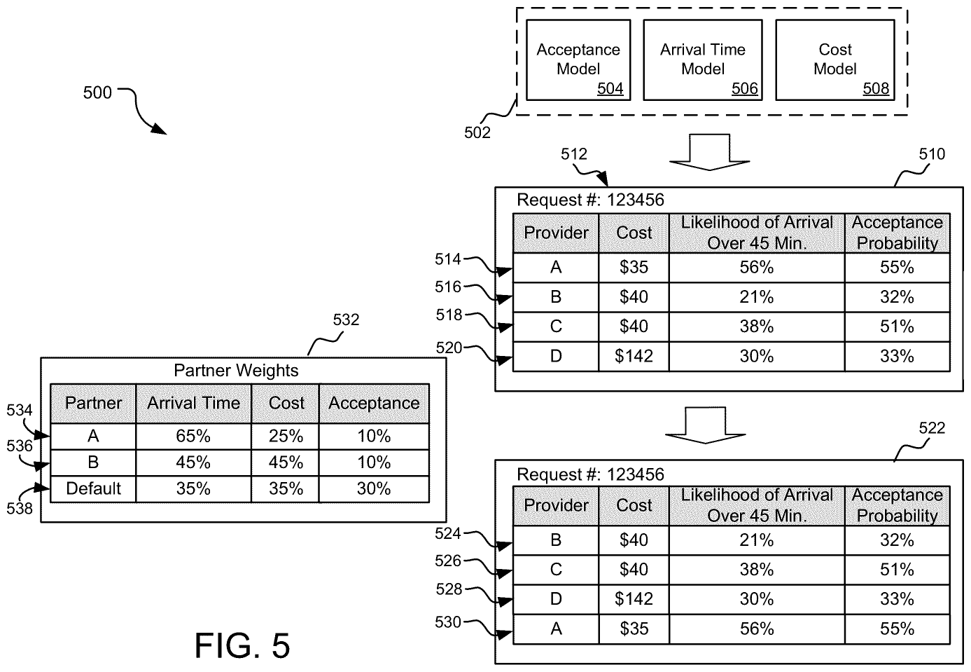

As mentioned above, one or more weighted values may be used to adjust a ranking of the identified roadside assistance providers. FIG. 5 illustrates a flowchart 500 for applying weighted values to an aggregated ranked list of roadside assistance providers for dispatching to a disabled vehicle. Any of the systems and methods discussed herein may be used to apply the weighted values to the aggregated ranked list of roadside assistance providers. For example, roadside assistance provider ranking system 400, and in particular the ranking service 404, may utilize the weight values stored in the weight database 406 to apply the values to a ranked list of roadside assistance providers, as described. Although discussed herein as performed by the ranking service 404, it should be appreciated that other components of the system 400 or of environment 100 may also utilize the weighted values.

As illustrated in FIG. 5, one or more predictive models 502 may be called by the ranking service 404 to generate predicted aspects of a roadside assistance. As discussed above, the ranking service 404 may call an acceptance model 504 that provides a predicted probability of acceptance of the roadside assistance by the each of the roadside assistance providers identified for a service area associated with the disabled vehicle, a cost model 508 that provides a predicted cost for each of the roadside assistance providers to provide the requested service, and/or an arrival time model 506 provides a predicted arrival time of the roadside assistance provider to the disabled vehicle. In one instance, the output of the arrival time model 506 may comprise a likelihood or probability that a dispatched service truck for the particular roadside assistance provider will arrive after a threshold timeframe. For example, the output of the arrival time model 506 may indicate a probability, illustrated as a percentage value, that a dispatched service truck for the particular roadside assistance provider will arrive after 45 minutes. The threshold value may be any time value. In an alternative instance, the output of the arrival time model 506 may comprise an estimated arrival time at the vehicle.

Upon receiving the output of the predictive models 502, the ranking service 404 may aggregate the outputs. In one example, the outputs of the predictive models 502 may be aggregated into a table for the particular request for roadside assistance. Table 510 illustrates one example of an aggregation of predictive model outputs for a request for roadside assistance. The table 510 may include an indicator 512 of the roadside assistance request. The table 510 may further include a column for each identified roadside assistance provider for the service area of the vehicle. In this example, four roadside assistance providers, labeled providers A-D, are listed, although more or fewer providers may be identified as providing roadside assistance for the area around the vehicle. The outputs from each of the predictive models 502 may be listed in additional columns for each roadside assistance provider, such as a column for the estimated cost for providing the roadside assistance, a column for the probability the service truck for that roadside assistance provider will arrive in over 45 minutes from dispatch, and a column listing the corresponding probability that roadside assistance provider will accept the request for the service. Additional or fewer columns displaying the outputs from other predictive models 502 may also be included. In the example illustrated in table 510, the predictive models indicate that Provider A 514 has an estimated cost of $35 for providing the service, has a 56% likelihood of arriving over 45 minutes from dispatch, and has a 55% probability of accepting the request for service. Similarly, Provider B 516 is illustrated has having an estimated cost of $40 for providing the service, a 21% likelihood of arriving over 45 minutes from dispatch, and a 32% probability of accepting the request for service, Provider C 518 has an estimated cost of $40 for providing the service, a 38% likelihood of arriving over 45 minutes from dispatch, and a 51% probability of accepting the request for service, and Provider D 520 has an estimated cost of $142 for providing the service, a 30% likelihood of arriving over 45 minutes from dispatch, and a 33% probability of accepting the request for service. The roadside assistance providers may be ranked in any manner, such as by the cost column as illustrated in table 510.

As mentioned, weighted values may be applied to the outputs of the predictive models 502 in the table 510. In one instance, the weighted values may be associated with a partner or other entity to the roadside assistance system. For example, a third-party entity, also referred to as a partner to the roadside assistance system, may provide one or more weighted values corresponding to the outputs from the predictive models 502 of the system to favor outputs more important to the third-party entity. FIG. 5 includes a partner weight table 532 that illustrates various weighted value associated with different partners of the roadside assistance system. In particular, the weight table 532 illustrates a first partner, Partner A 534, is associated with a weighted value of 65% for an estimated arrival time output, a weighted value of 25% for an estimated cost output, and a weighted value of 10% for an estimated acceptance output. The weight table 532 also indicates Partner B 536, is associated with a weighted value of 45% for an estimated arrival time output, a weighted value of 45% for an estimated cost output, and a weighted value of 10% for an estimated acceptance output. The weight table 532 may also include one or more default weighted values for application to requestors of a roadside assistance that are not affiliated with Partner A or Partner B. The default weighted values are illustrated as a weighted value of 35% for an estimated arrival time output, a weighted value of 35% for an estimated cost output, and a weighted value of 30% for an estimated acceptance output. It should be appreciated that any weighted value may be associated with any predictive model output as associated with a partner to the roadside assistance system or associated with a non-partner to the system.

To determine the weighted values to a particular request for a roadside assistance, the roadside assistance system may attempt to correspond an identification of a requestor for the assistance or a make and/or model of the vehicle to a partner entity. For example, the request for the roadside assistance received at the roadside assistance system may include a user identifier or an identifier of the disabled vehicle. The roadside assistance system may correlate the user identifier or a make/model of the vehicle to a third-party entity partner of the roadside assistance system. If the user or the vehicle is associated with a partner to the roadside assistance system, the corresponding weighted values from the partner weight table 532 may be applied to the outputs 510 of the predictive models 502.

Application of the weighted values 532 may adjust the ranking of the outputs of the predictive models 502. In the example illustrated in FIG. 5, the user or vehicle may be identified as associated with Partner A such that the weighted values corresponding to Partner A 534 may be applied to the predictive model outputs 510. As shown, the weighted values associated with Partner A 534 may include a 65% weighted value for the estimated arrival time output, a 25% weighted value for the cost output, and a 10% weighted value for the acceptance output. Thus, the estimated arrival time output is weighted heavier than the other output values. Application of a weighted value to a model output may include multiplying the output value by the weighted value. In general, however, any known or hereafter developed method for application of a weighted value to a model output value may be used in conjunction with the roadside assistance system.

In another example, the user or vehicle may be identified as associated with Partner B such that the weighted values corresponding to Partner B 536 may be applied to the predictive model outputs 510. As shown, the weighted values associated with Partner B 536 may include a 45% weighted value for the estimated arrival time output, a 45% weighted value for the cost output, and a 10% weighted value for the acceptance output. Because the weighted values associated with Partner B 536 are similar between the estimated arrival time output and the cost output, neither output is preferred by Partner B over the other output. However, the weighted values associated with Partner B 536 create a preference of either estimated arrival time or cost compared to the acceptance rate.

The partner weight table, or more specifically the weight database 406, may also include default weighted values 538. The default weighted values 538 may be applied for roadside assistance requests that include a user or vehicle that is otherwise not associated with a partner to the roadside assistance system. In some instances, the default weighted values 538 may be set to balance the outputs of the predictive models 502 evenly or similarly. In other instances, the default weighted values may be set to prefer one or more outputs over others. For example, the default weighted values may be utilized by the ranking service 404 to adjust the ranking parameters stored in the ranking parameters database 420, such as based on feedback results received from previous rankings of roadside assistance providers. Adjustment of the parameters in the ranking parameters database 420 is discussed in more detail below.

Returning to the above example in which the user or vehicle of the roadside assistance request is associated with third-party partner A, the weighted values corresponding to Partner A 534 from the weight table 406 may be applied to the received output values 512 from the predictive models 502. The ranking service 404 may then re-rank the roadside assistance providers according to the weighted values associated with the partner agreement or based on the default weighted values if the user or vehicle is not associated with a partner to the roadside assistance system. In the illustrated example of FIG. 5, roadside assistance provider A 530 may be re-ranked to the bottom of the re-ranked list 522 because the likelihood of provider A arriving in over 45 minutes is higher than the other ranked roadside assistance providers and the weighted values associated with Partner A 534 includes a relatively high weighted value for arrival time. Thus, the Partner A 534 weighted values indicate a preference for arrival time over other predictive model outputs, such that those roadside assistance providers with a high likelihood of a long arrival time may be re-ranked 522 toward the bottom of the ranked list of providers. In this manner, the weighted values may be utilized to preference one or more model output values over other output values. The ranking service 404 may then provide the re-ranked list 522 to the requesting device for selection of a roadside assistance provider to dispatch, most likely provider B in this example as provider B has the highest ranking after application of the weighted values.

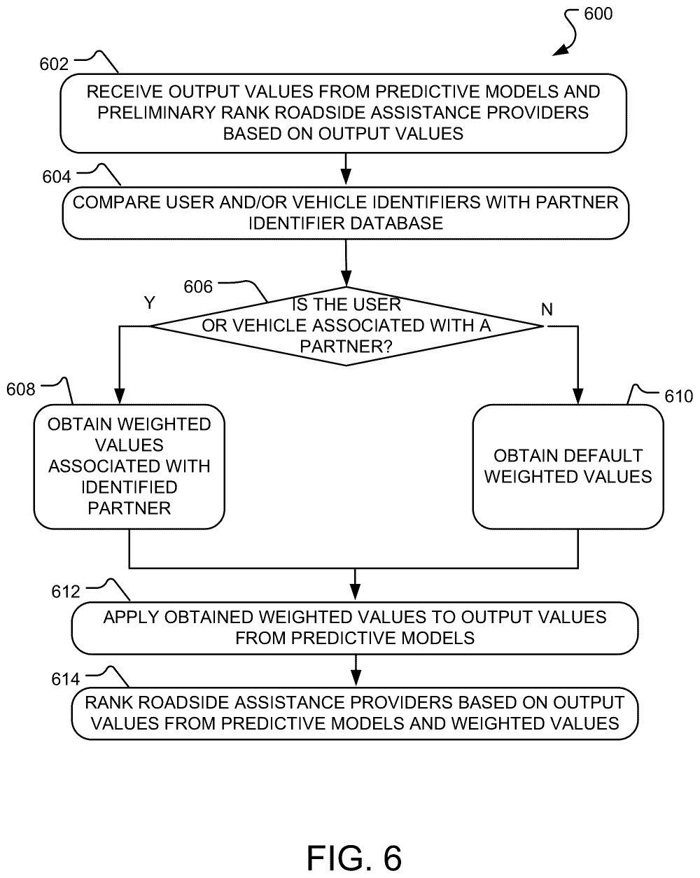

FIG. 6 is a flowchart illustrating an example method 600 for applying one or more weighted values to outputs of predictive models for ranking roadside assistance providers for dispatching to a disabled vehicle. At operation 602, output values from one or more predictive models may be received and, in some instances, a preliminary ranking of the roadside assistance providers based on those output values may be generated. For example, and as illustrated in FIG. 5, one or more predictive models 502 may provide outputs of predictive values that may be utilized to rank roadside assistance providers, as shown in Table 510. At operation 604, a user and/or vehicle identifier may be compared to a database of identifiers associated with third-party partners of a roadside assistance providers. For example, an identifier of a user from which a request for a roadside assistance is received may be compared to a database of such identifiers that are associated with one or more business partners or other third-party entities of the roadside assistance system. In another example, an identifier of a vehicle associated with the roadside assistance request, such as a vehicle make/model identifier, may be compared to the database. In some instance, the entity for which the identifier is associated may be a group of users within the roadside assistance system for which particular weighted values are correlated. Regardless, it may be determined, at operation 606, if the identifier associated with the request is included in a group or partner of the roadside assistance system.

If the user or vehicle is associated with a partner or group, one or more weighted values associated with the partner or group may be obtained in operation 608. Weighted values may take many forms, such as a percentage value, a decimal value, or any other value that may be applied to an output of the predictive models to adjust the output value according to the weighted value. If the user or vehicle is not associated with a partner or group, one or more default weighted values may be obtained in operation 610. The obtained weighted values may be applied to the output values of the predictive models at operation 612. In one instance, application of the weighted values to the output values may include multiplying the weighted values to the output values, although other methods may be used to apply the weighted values. At operation 614, the roadside assistance providers may be ranked based on the output values of the predictive models and the applied weighted values to the output values. The ranked roadside assistance providers may then be provided to a requesting device for use in selecting a roadside assistance provider to provide a roadside service.

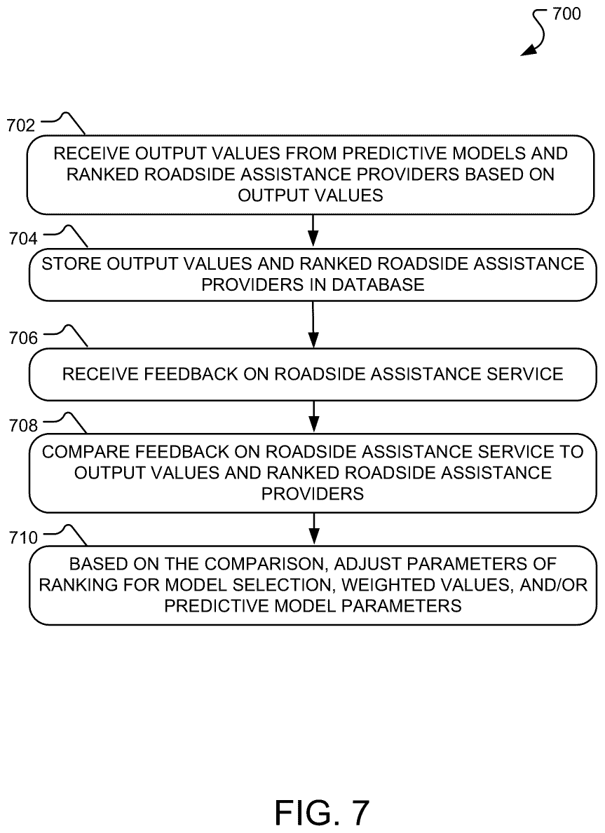

As mentioned above, the roadside assistance system may be a machine-learning system that utilizes past rankings of roadside assistance providers and/or output values of predictive models to adjust one or more ranking parameters, one or more of the predictive models, or any other aspect of the roadside assistance system to optimize the operation and effectiveness of the system. FIG. 7 is a flowchart illustrating an example method 700 for altering a component or aspect of a roadside assistance system based on feedback information and data. The operations of the method 700 may be performed by any computing device associated with the roadside assistance system discussed herein or any combination of components or computing devices of the system. Further, aspects of the roadside assistance provider ranking system 400 may be utilized, such as the ranking results database 418, the ranking parameters database 420, the ranking service 404, and the like of the system of FIG. 4. Thus, although discussed herein with reference to the components of the roadside assistance provider ranking system 400, it should be appreciated that other components, computing devices, computing systems, etc. may execute one or more commands or procedures to perform the operations of the method 700.

At operation 702, output values from one or more predictive models, such as acceptance model 426, arrival time model 428, out-of-network model 430, cost model 432, multi-criteria model 434, and others, may be received. As described above, the predictive models may include predictive output values corresponding to aspects of a roadside assistance, such as an estimated time of arrival or a probability that a service vehicle will arrive after a particular amount of time, a probability that a particular roadside assistance provider will accept to provide the service, an estimated cost for performing the service, and others. In one implementation, the output values may be received at the ranking service 404 and, based on the output values, the ranking service may rank identified roadside assistance providers for given service. The ranked roadside assistance providers may be provided to a requesting device, such as controller 402. In addition to using the output values to rank the roadside assistance providers, the ranking service 404 may also store, at operation 704, the output values in the ranking results database 418 as accessed through the ranking data service 416. The output values from the predictive models 424 may be stored associated with other information or data of the requested roadside assistance for which the output values were generated by the models. For example, the output values of the models 424 may be correlated with a user identifier of the service request, vehicle information and/or an identifier, a geographic location of the vehicle, a time of day the roadside assistance request is received, and any other information or data generated or received by the roadside assistance system associated with the roadside assistance request. The ranking of the roadside assistance providers by the ranking service 404 may also be stored in the ranking results database 418, correlated or not with the output values received from the predictive models 424.

The ranking of the roadside assistance providers, based on the output values of the predictive models 424, may be used to select a roadside assistance provider to perform the requested roadside assistance, perhaps by the controller 402 or other computing device. Selection of a roadside assistance provider may include transmitting a request for the selection roadside assistance provider to provide the service or otherwise communicating with the selected roadside assistance provider, receiving an acceptance or denial of the request, and performance of the roadside assistance by the selected provider. Metrics associated with the roadside assistance may also be collected by the controller 402 or other component of the roadside assistance system. Such metrics may include time to arrive at the vehicle, agree upon cost for providing the roadside assistance, an indication of acceptance or denial by the selected roadside assistance provider, the ranking of the roadside assistance provider that accepts the roadside assistance request, and the like. At operation 706, the information and data associated with performing the roadside assistance, also referred to herein as feedback, may be received and, in some instances, stored in a database, such as the ranking results database 418 or other database. In general, any information or data associated with the selection and requesting of a roadside assistance provider and the performance of the roadside assistance provider may be received and stored.

At operation 708, the feedback information of the roadside assistance may be compared to the output values and/or the ranked roadside assistance providers stored in the ranking results database 418. For example, the feedback information may include a time to arrival measured from the time the roadside assistance provider accepted the assistance request to the time the service truck arrived at the vehicle. The actual time to arrival may be compared to the estimated time to arrival output generated by the arrival time predictive model 428. In another example, the predictive acceptance model 426 may provide a likelihood of acceptance for a particular roadside assistance provider as an output. The acceptance or denial to the request by the roadside assistance provider may be compared to an indication of acceptance or denial by the roadside assistance provider included in the feedback. In yet another example, the predictive cost model 432 may output a predicted cost for performing the roadside assistance for one or more providers. An actual cost for performing the assistance may then be compared to the predicted cost. In general, any predictive output from the predictive models 424 may be compared to any aspect of the feedback data.

Comparison of the feedback data to the model outputs may indicate an accuracy of the predictive outputs to the corresponding actual measurement, information, or data associated with the roadside assistance service. For example, the comparison may indicate that the predicted time of arrival was slower than the actual time of arrival by the dispatched service truck. The comparison may also indicate that the predicted cost to dispatch the service truck for the roadside assistance provider was higher than the actual, agreed upon cost for performing the service. The comparison may further indicate an accuracy of a ranking of the roadside assistance providers. For example, the ranking service 404 may rank a particular roadside assistance provider first. However, the controller 402 or other selecting device or system may select a different roadside assistance provider, for any number of reasons such as a denial by the roadside assistance provider to the request for service, an estimated cost that exceeds an upper threshold value, the estimated time for the highest ranked roadside assistance provider exceeding an upper threshold, and the like. The feedback information may indicate which roadside assistance provider of the ranked providers that is ultimately selected and dispatched to provide the requested roadside assistance and the comparison to the stored ranked list of providers may indicate a position within the ranking of the selected roadside assistance provider. In general, a difference between the predicted output value and/or ranked list of roadside assistance providers and the corresponding feedback values or information may be calculated for one or more aspects of the roadside assistance and, as explained below, used to adjust one or more aspects of the roadside assistance system to tune the predictive models 424 to provide a more accurate prediction.

At operation 710, one or more aspects of the roadside assistance system may be adjusted based on the comparison of the feedback information and the output value and/or ranking of the roadside assistance providers. In one instance, the comparison may indicate a difference between the predicted outputs from the models 424 and the corresponding feedback information, such as a difference between the estimated time of arrival and the actual time of arrival. In such cases, the corresponding predictive model may be adjusted in response to the determined difference. For example, the acceptance model 426 may be adjusted to provide a lower probability of acceptance output for a particular roadside assistance provider based on the provider denying a request for a roadside assistance. Subsequent executions of the acceptance model 426 for that roadside assistance provider may result in a lower probability the roadside assistance provider will accept the request. Similarly, the feedback information may indicate that a roadside assistance provider arrived before an estimated arrival time provided by the arrival time model 428. The arrival time model 428 may therefore be adjusted to lower the estimated arrival time for that roadside assistance provider based on the comparison, or for any roadside assistance providers either in the particular service area or in any service area. In general, any predictive model 424 utilized by the roadside assistance system may be adjusted based on feedback information provided to the roadside assistance system corresponding to a dispatched roadside assistance provider. Such adjustments may be applied to predictive models designed for particular roadside assistance providers, particular service areas, global roadside assistance providers, global service areas, or any other predictive models.

In another example, one or more ranking parameters stored in the ranking parameters database 420 may be adjusted or altered in response to the stored ranking results or output values from the predictive models 424. As explained above, the ranking parameters may include instructions for the ranking service 404 when ranking roadside assistance providers based on the outputs of the predictive models 424. The ranking parameters may include a preference of a particular output or outputs over other outputs from the models. In general, the ranking parameters may provide a control system for the ranking service 404 when ranking the identified roadside assistance providers using the output values of the predictive models 424. The comparison of the feedback information to the stored ranking results may indicate that the ranked list of roadside assistance providers did not provide the most efficient or “best” provider at the top of the list. Based on the selected roadside assistance provider and the output values of the predictive models 424, one or more ranking parameters may be adjusted to control the ranking of the roadside assistance providers by the ranking service 404 to a more accurate ranking of the providers and place the most likely selected provider at the top of the ranked list. In a similar manner, one or more of the weighted values of the weight database 406 may be adjusted to control the ranking service 404 to prefer some output values over others when ranking the roadside assistance providers based on the output values of the predictive models 424. For example, default weighted values may be adjusted to preference an arrival time predicted output from the arrival time model 428 over other output values in response to the comparison of the feedback information to the stored output values and/or ranked list of roadside assistance providers. In another embodiment, however, the weighted values may not be adjusted by the roadside assistance system but may only be adjusted by a third-party entity provided access to the weight database 406.

In still another example, aspects of the endpoint navigator 414 may be adjusted in response to the comparison of the feedback information to the stored output values and/or ranked list of roadside assistance providers. As described above, the endpoint navigator 414 may select which predictive model 424 is used to generate a ranked list of roadside assistance providers for a roadside assistance request. In some instances, the endpoint navigator 414 may select more than one predictive model 424 to provide outputs to the ranking service 404. For example, the acceptance model 426 may provide acceptance probability outputs and the multi-criteria model 434 may provide outputs based on multiple roadside assistance criteria. The ranking service 404 may or may not use the outputs from both or either model when ranking the roadside assistance providers for the requested service. Regardless, the outputs and the ranked list of roadside assistance providers may be stored and compared to feedback information associated with the roadside assistance service. For example, a ranked list of roadside assistance providers based on the output of the acceptance model 426 and a different ranked list based on the output of the multi-criteria model 434 may be compared to the feedback information from the roadside assistance service. The ranked list that most closely matches the feedback information may then be identified and the endpoint navigator 414 may be adjusted to more often select the predictive model that corresponds to the more accurate ranked list of providers. For example, a comparison of the ranked lists to the feedback information may indicate that the multi-criteria model 434 provides a more accurate ranked list of roadside assistance providers in many circumstances. Thus, the endpoint navigator 414 may be adjusted to select the multi-criteria model 434 for providing output values to the ranking service 404 more often than other predictive models. Alternatively, other predictive models may be determined to be more accurate in providing output values for generating a ranked list of roadside assistance providers and the endpoint navigator 414 may be adjusted to prefer the other predictive models accordingly. In still another example, the endpoint navigator 414 may be adjusted, based on the comparison of the feedback information to the stored rankings and/or output values, to provide outputs from multiple predictive models 424 to the ranking service 404, exclude outputs from one or more predictive models, combine outputs from a plurality of predictive models, and the like. In general, the endpoint navigator 414 may be adjusted in any manner in response to the comparison of the feedback information and data to the stored ranked lists of roadside assistance providers and the output values.

In this manner, the roadside assistance system may be a machine-learning system that utilizes past rankings of roadside assistance providers and/or output values of one or more predictive models 424 to adjust one or more ranking parameters, one or more of the predictive models, or any other aspect of the roadside assistance system to optimize the operation and effectiveness of the system. Several aspects of the roadside assistance system may be modified, adjusted, or altered based on feedback information of a roadside assistance service, such as aspects of one or more predictive models 424, one or more weighted values of parameters, a predictive model selector, and the like. The roadside assistance system may thus become more efficient and accurate in providing a ranked list of roadside assistance providers for a given roadside assistance request.

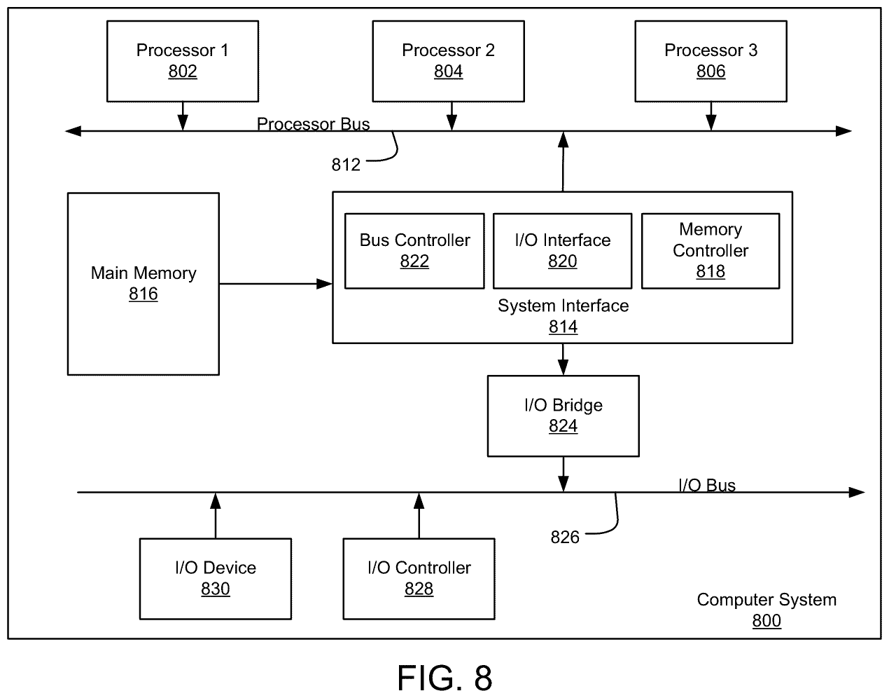

FIG. 8 is a block diagram illustrating an example of a computing device or computer system 800 which may be used in implementing the embodiments of the components of the network disclosed above. For example, the computing system 800 of FIG. 8 may be the mobile device 102 or one or more of the servers 108, 110 of the roadside assistance system discussed above. The computer system (system) includes one or more processors 802-806. Processors 802-806 may include one or more internal levels of cache (not shown) and a bus controller or bus interface unit to direct interaction with the processor bus 812. Processor bus 812, also known as the host bus or the front side bus, may be used to couple the processors 802-806 with the system interface 814. System interface 814 may be connected to the processor bus 812 to interface other components of the system 800 with the processor bus 812. For example, system interface 814 may include a memory controller 818 for interfacing a main memory 816 with the processor bus 812. The main memory 816 typically includes one or more memory cards and a control circuit (not shown). System interface 814 may also include an input/output (I/O) interface 820 to interface one or more I/O bridges or I/O devices with the processor bus 812. One or more I/O controllers and/or I/O devices may be connected with the I/O bus 826, such as I/O controller 828 and I/O device 830, as illustrated.

I/O device 830 may also include an input device (not shown), such as an alphanumeric input device, including alphanumeric and other keys for communicating information and/or command selections to the processors 802-806. Another type of user input device includes cursor control, such as a mouse, a trackball, or cursor direction keys for communicating direction information and command selections to the processors 802-806 and for controlling cursor movement on the display device.

System 800 may include a dynamic storage device, referred to as main memory 816, or a random access memory (RAM) or other computer-readable devices coupled to the processor bus 812 for storing information and instructions to be executed by the processors 802-806. Main memory 816 also may be used for storing temporary variables or other intermediate information during execution of instructions by the processors 802-806. System 800 may include a read only memory (ROM) and/or other static storage device coupled to the processor bus 812 for storing static information and instructions for the processors 802-806. The system set forth in FIG. 8 is but one possible example of a computer system that may employ or be configured in accordance with aspects of the present disclosure.

According to one embodiment, the above techniques may be performed by computer system 800 in response to processor 804 executing one or more sequences of one or more instructions contained in main memory 816. These instructions may be read into main memory 816 from another machine-readable medium, such as a storage device. Execution of the sequences of instructions contained in main memory 816 may cause processors 802-806 to perform the process steps described herein. In alternative embodiments, circuitry may be used in place of or in combination with the software instructions. Thus, embodiments of the present disclosure may include both hardware and software components.

A machine-readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available through a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 806 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 816, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

What is claimed is:

1. A method for identifying a roadside assistance provider, the method comprising:
determining, based on information received from a roadside assistance request, a plurality of roadside assistance providers associated with a service area corresponding to the roadside assistance request;
receiving one or more predicted values from a plurality of prediction models, wherein each of the one or more predicted values corresponds to an aspect of providing the requested roadside assistance and associated with each of the plurality of roadside assistance providers;
ranking the plurality of roadside assistance providers based at least on one of the one or more predicted values from the plurality of prediction models;
selecting, based on the ranked plurality of roadside assistance providers, a roadside assistance provider to provide the requested roadside assistance in response to the roadside assistance request; and
altering, based on feedback information associated with the selected roadside assistance provider providing the requested roadside assistance, at least one of the plurality of prediction models.

2. The method of claim 1 wherein the roadside assistance request comprises a location identifier associated with a vehicle of the roadside assistance request, wherein the one or more predicted values is based on the location identifier associated with the vehicle.

3. The method of claim 2, further comprising:
calculating an estimated distance for each of the plurality of roadside assistance providers based on the location identifier associated with the vehicle.

4. The method of claim 1 wherein the plurality of prediction models comprises an estimated time to arrival prediction model, the one or more predicted values comprising an estimated time to arrival associated with each of the roadside assistance providers generated by the estimated time to arrival prediction model.

5. The method of claim 1 wherein the plurality of prediction models comprises an acceptance prediction model, the one or more predicted values comprising an estimated probability of acceptance of an offer to provide the requested roadside assistance associated with each of the roadside assistance providers generated by the acceptance prediction model.

6. The method of claim 1 wherein the plurality of prediction models comprises a cost prediction model, the one or more predicted values comprising an estimated cost associated with each of the roadside assistance providers to provide the roadside assistance generated by the cost prediction model.

7. The method of claim 1 wherein the plurality of prediction models comprises a multi-criteria prediction model, the one or more predicted values comprising an estimated time to arrival and an estimated probability of acceptance of an offer to provide the requested roadside assistance associated with each of the roadside assistance providers generated by the multi-criteria prediction model.

8. The method of claim 1 wherein ranking the plurality of roadside assistance providers is further based on one or more ranking parameters each comprising a rule for ranking the plurality of roadside assistance providers based at least on the one of the one or more predicted values from the plurality of prediction models.

9. The method of claim 1, further comprising:
determining an identifier received from the roadside assistance request;
obtaining one or more weighted values associated with the identifier, each of the one or more weighted values corresponding to at least one of the one or more predicted values from the plurality of prediction models; and
applying the one or more weighted values to the corresponding one or more predicted values prior to ranking the plurality of roadside assistance providers.

10. The method of claim 9 wherein the identifier is associated with a user of a communication device from which the roadside assistance request is received.

11. The method of claim 9 wherein the identifier is associated with a vehicle of the roadside assistance request.

12. The method of claim 9 wherein the identifier corresponds to one or more third-party entities and the one or more weighted values are received from a computing device associated with the one or more third-party entities.

13. A roadside assistance provider selection system comprising:
a processing device in communication with a network and receiving a roadside assistance request from a mobile device, the roadside assistance request comprising at least a geographic location; and
a non-transitory database for a plurality of roadside assistance providers each associated with a corresponding service area;
wherein the processing device executes one or more instructions that cause the processing device to perform the operations of:
determining, based on the geographic location, a subset of roadside assistance providers associated with a service area corresponding to the roadside assistance request;
calculating an estimated distance for each of the subset of roadside assistance providers based on the geographic location;
receiving, based on the estimated distance for each of the subset of roadside assistance providers, one or more predicted values from a plurality of prediction models, wherein each of the one or more predicted values corresponds to an aspect of providing the requested roadside assistance and associated with each of the subset of roadside assistance providers;
ranking the subset of roadside assistance providers based at least on one of the one or more predicted values from the plurality of prediction models; and
altering, based on feedback information associated with the selected roadside assistance provider providing the requested roadside assistance, at least one of the plurality of prediction models.

14. The roadside assistance provider selection system of claim 13 wherein the plurality of prediction models comprises an estimated time to arrival prediction model, the one or more predicted values comprising an estimated time to arrival associated with each of the roadside assistance providers generated by the estimated time to arrival prediction model and based on the geographic location.

15. The roadside assistance provider selection system of claim 13 wherein the plurality of prediction models comprises an acceptance prediction model, the one or more predicted values comprising an estimated probability of acceptance of an offer to provide the requested roadside assistance associated with each of the roadside assistance providers generated by the acceptance prediction model.

16. The roadside assistance provider selection system of claim 13, wherein the processing device further executes the one or more instructions to cause the processing device to perform the operations of:
determining an identifier received from the roadside assistance request;
obtaining one or more weighted values associated with the identifier, each of the one or more weighted values corresponding to at least one of the one or more predicted values from the plurality of prediction models; and
applying the one or more weighted values to the corresponding one or more predicted values prior to ranking the subset of roadside assistance providers.

17. The roadside assistance provider selection system of claim 16 wherein the identifier is associated with a user of the mobile device from which the roadside assistance request is received or a vehicle of the roadside assistance request.

18. One or more tangible non-transitory computer-readable storage media storing computer-executable instructions for performing a computer process on a server of a network, the computer process comprising the method of:
determining, based on information received from a roadside assistance request, a plurality of roadside assistance providers associated with a service area corresponding to the roadside assistance request;
receiving one or more predicted values from a plurality of prediction models, wherein each of the one or more predicted values corresponds to an aspect of providing the requested roadside assistance and associated with each of the plurality of roadside assistance providers;
ranking the plurality of roadside assistance providers based at least on one of the one or more predicted values from the plurality of prediction models;
selecting, based on the ranked plurality of roadside assistance providers, a roadside assistance provider to provide the requested roadside assistance in response to the roadside assistance request; and
altering, based on feedback information associated with the selected roadside assistance provider providing the requested roadside assistance, at least one of the plurality of prediction models.

19. The one or more tangible non-transitory computer-readable storage media of claim 18 storing computer-executable instructions for performing a computer process on the server of the network, the computer process further comprising the method:
determining an identifier received from the roadside assistance request;
obtaining one or more weighted values associated with the identifier, each of the one or more weighted values corresponding to at least one of the one or more predicted values from the plurality of prediction models; and
applying the one or more weighted values to the corresponding one or more predicted values prior to ranking the plurality of roadside assistance providers.

20. The one or more tangible non-transitory computer-readable storage media of claim 18, wherein the plurality of prediction models comprises a multi-criteria prediction model, the one or more predicted values comprising an estimated time to arrival and an estimated probability of acceptance of an offer to provide the requested roadside assistance associated with each of the roadside assistance providers generated by the multi-criteria prediction model.
